(19) United States
(12) Patent Application Publication
(10) Pub. No.: US 2026/0311058 A1
(43) Pub. Date: Oct. 8, 2026

(54) ELECTRONIC DEVICE AND OPERATION METHOD OF THE ELECTRONIC DEVICE

(71) Applicant: Samsung Electronics Co., Ltd., Suwon-si (KR)

(72) Inventors: Sihyun CHOI, Suwon-si (KR); Junho LEE, Suwon-si (KR); Yoojin CHOI, Suwon-si (KR); Jiyun SHIN, Suwon-si (KR); Seungjin CHOI, Suwon-si (KR)

(73) Assignee: Samsung Electronics Co., Ltd., Suwon-si (KR)

(21) Appl. No.: 19/629,889

(22) Filed: Mar. 26, 2026

(30) Foreign Application Priority Data
Apr. 2, 2025 (KR) 10-2025-0043119

(51) Int. Cl. G06N 20/00

(52) U.S. Cl. CPC G06N 20/00

(57) ABSTRACT

An electronic device includes a memory storing a first Artificial Intelligence (AI) model and a second AI model, the first AI model being trained to determine whether training input data is Out-Of-Distribution (OOD) data, the second AI model being trained to perform a first inference operation based on the training input data, and processing circuitry configured to determine whether first input data is the OOD data by using the first AI model, generate a first inference result by performing the first inference operation using one of the second AI model or a legacy algorithm based on whether the first input data is the OOD data, and perform a control operation based on the first inference result.

### CROSS-REFERENCE TO RELATED APPLICATION

This application is based on and claims priority under 35 U.S.C. § 119 to Korean Patent

Application No. 10-2025-0043119, filed on Apr. 2, 2025, in the Korean Intellectual Property Office, the disclosure of which is incorporated by reference herein in its entirety.

### BACKGROUND

The inventive concepts relate to an electronic device for performing an inference operation based on input data.

Recently, as Artificial Intelligence (AI) technology advances, electronic devices may process various operations by using AI technology. For example, when electronic devices communicate with electronic devices external thereto, the electronic devices may perform various operations (for example, beam tracking) for ensuring communication performance, by using AI models. Here, AI models may perform training by using particular data distributions and may process input data based on trained results. Here, when there is a difference between data trained by AI models and input data, inference performance of the AI models may deteriorate, and thus, the performance of electronic devices may deteriorate.

### SUMMARY

The inventive concepts provide an electronic device for performing an inference operation by a different method according to a relationship between training data and input data.

According to an aspect of the inventive concepts, there is provided an electronic device including a memory storing a first Artificial Intelligence (AI) model and a second AI model, the first AI model being trained to determine whether training input data is Out-Of-Distribution (OOD) data, the second AI model being trained to perform a first inference operation based on the training input data, and processing circuitry configured to determine whether first input data is the OOD data by using the first AI model, generate a first inference result by performing the first inference operation using one of the second AI model or a legacy algorithm based on whether the first input data is the OOD data, and perform a control operation based on the first inference result.

According to an aspect of the inventive concepts, there is provided an electronic device including a memory storing a first Artificial Intelligence (AI) model and a second AI model, the first AI model being trained to determine whether training input data is Out-Of-Distribution (OOD) data, the second AI model being trained to perform a first inference operation based on the training input data, and processing circuitry configured to determine whether first input data is the OOD data using the first AI model, generate a first inference result by performing the first inference operation using one of the second AI model, or as a result of performing a previous first inference operation based on whether the first input data is the OOD data, and perform a control operation based on the first inference result.

According to an aspect of the inventive concepts, there is provided an operation method of an electronic device, the operation method including receiving first input data, determining whether the first input data is Out-Of-Distribution (OOD) data using a first Artificial Intelligence (AI) model, generating a first inference result by performing a first inference operation using a second AI model in response to determining the first input data is the OOD data, performing a first control operation based on the first inference result, receiving second input data, determining whether the second input data is the OOD data using the first AI model, generating a second inference result by using one of a legacy algorithm or a result of performing a previous first inference operation, and performing a second control operation based on the second inference result.

### BRIEF DESCRIPTION OF THE DRAWINGS

Embodiments will be more clearly understood from the following detailed description taken in conjunction with the accompanying drawings in which:

FIG. 1 is a block diagram illustrating a wireless communication system according to embodiments;

FIG. 2 is a block diagram illustrating an electronic device according to embodiments;

FIG. 3 is a diagram illustrating Out-Of-Distribution (OOD) data and a relationship between training data and input data;

FIG. 4 is a first example of a method, performed by an electronic device, of generating an inference result based on input data, according to embodiments;

FIG. 5 is a second example of a method, performed by an electronic device, of generating an inference result based on input data, according to embodiments;

FIG. 6 is a third example of a method, performed by an electronic device, of generating an inference result based on input data, according to embodiments;

FIG. 7 is a fourth example of a method, performed by an electronic device, of generating an inference result based on input data, according to embodiments;

FIG. 8 is a fifth example of a method, performed by an electronic device, of generating an inference result based on input data, according to embodiments;

FIG. 9 is a flowchart illustrating an operation method of an electronic device, according to embodiments;

FIG. 10 is a flowchart illustrating an additional operation method of an electronic device, according to embodiments;

FIG. 11 is a flowchart illustrating a method, performed by an electronic device, of determining whether there is a need to update (or whether to update) a second Artificial Intelligence (AI) model, according to embodiments; and

FIG. 12 is a block diagram illustrating a user equipment according to embodiments.

### DETAILED DESCRIPTION

Hereinafter, embodiments of the inventive concepts will be described in detail with reference to the accompanying drawings.

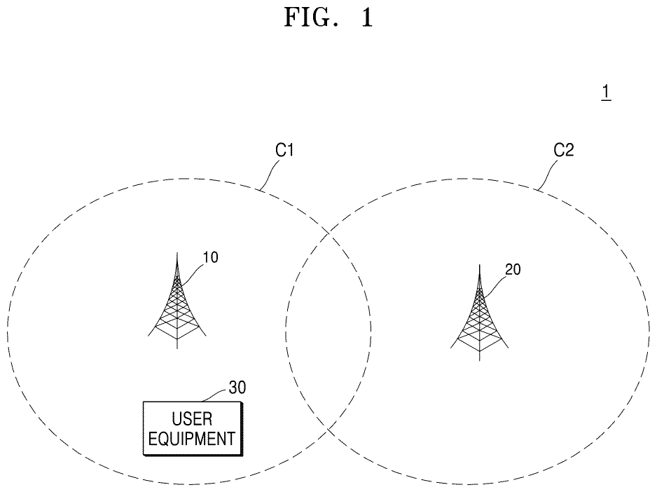

FIG. 1 is a block diagram illustrating a wireless communication system according to embodiments.

Referring to FIG. 1, a wireless communication system 1 may include base stations (that is, 10 and 20) and/or a user equipment 30.

The wireless communication system 1 may provide, to the user equipment 30, a communication service based on at least one of a plurality of wireless networks. For example, the wireless communication system 1 may provide a communication service based on at least one network from among a 3rd-generation (3G) network, a 4th-generation (4G) network, a wireless broadband (Wibro) network, a global system for mobile communication (GSM) network, a 5th-generation (5G) network, a 6th-generation (6G) network, etc.

Various functions described below may be implemented or supported by Artificial Intelligence (AI) technology or by one or more computer programs, and each of the programs includes computer-readable program code and is implemented on a non-transitory computer-readable medium. The terms “application” and “program” refer to one or more computer programs, software components, instruction sets, procedures, functions, objects, classes, instances, related data, or portions thereof suitable for the implementation of suitable computer-readable program code. The term “computer-readable program code” includes any types of computer code including source code, object code, and execution code. The term “computer-readable medium” includes any types of media, such as read-only memory (ROM), random access memory (RAM), hard disk drives, compact discs (CDs), digital video disks (DVDs), or any other types of memory, which may be accessed by computers. A “non-transitory” computer-readable medium does not include wired, wireless, optical, or other communication links for transmitting temporary electrical or other signals. Non-transitory computer-readable media include media in which data may be permanently stored, and media in which data may be stored and overwritten afterward, such as rewritable optical disks or erasable memory devices.

In embodiments described below, a hardware approach is described as an example. However, because embodiments of the inventive concepts include a technique using both hardware and software, embodiments do not exclude software-based approaches.

Each of the base stations 10 and 20 may generally refer to a fixed station communicating with the user equipment 30 and may exchange control information and data with the user equipment 30 by communicating with the user equipment 30. For example, a base station may be variously referred to as a Node B, an evolved-Node B (eNB), a next-generation Node B (gNB), a sector, a site, a base transceiver system (BTS), an access point (AP), a relay node, a remote radio head (RRH), a radio unit (RU), a small cell, a wireless device, a device, or the like.

Although FIG. 1 illustrates an example in which the wireless communication system 1 includes two base stations (that is, 10 and 20), such as a first base station 10 and a second base station 20, the inventive concepts are not limited thereto. Unlike the example shown in FIG. 1, the wireless communication system 1 may include one base station (that is, 10 or 20) or three or more base stations (that is, 10, 20 and at least one other base station).

The user equipment 30 may refer to any equipment that is stationary or mobile and may transmit data and/or control information to and receive data and/or control information from the first base station 10 by communicating with the first base station 10. For example, the user equipment 30 may be referred to as a terminal, terminal equipment, a mobile station (MS), a mobile terminal (MT), a user terminal (UT), a subscribe station (SS), a wireless communication device, a wireless device, a handheld device, or the like.

Although FIG. 1 illustrates an example in which the wireless communication system 1 includes one user equipment 30, the inventive concepts are not limited thereto. Unlike the example shown in FIG. 1, the wireless communication system 1 may include two or more user equipments 30.

The base stations (that is, 10 and 20) may be connected to the user equipment 30 within respective coverages (that is, C1 and C2, respectively) and may provide communication services to the user equipment 30, based on wireless networks. In the example of FIG. 1, the first base station 10 may be connected to the user equipment 30 within a first coverage C1. Unlike the example shown in FIG. 1, when the user equipment 30 is located within a second coverage C2, the second base station 20 may be connected to the user equipment 30.

The user equipment 30 may move within the first coverage C1. When the user equipment 30 moves within the first coverage C1, the user equipment 30 may perform a beam tracking operation to communicate with the first base station 10 by using an appropriate beam according to a change in the position thereof. Here, by periodically performing the beam tracking operation, the user equipment 30 may always (or more often) perform communication by using an appropriate beam even when the position of the user equipment 30 changes. Likewise, by performing the beam tracking operation, the base stations (that is, 10 and 20) may adjust, in real time, the direction of a beam transmitted to the user equipment 30.

The beam tracking operation may be performed in the manner of selecting an optimum beam (or a beam having a highest signal strength) via an AI model based on a signal received from the user equipment 30. Here, the AI model may generate an inference result by using, as input data, the signal received from the user equipment 30. When the beam tracking operation is performed as such, in the case where the input data drastically (or significantly) changes due to signal blocking, multipath interference, rapid movement of a terminal, an environmental change, or the like, and thus has a great (or significant) difference from training data used for training the AI model, the inference performance of the AI model may deteriorate.

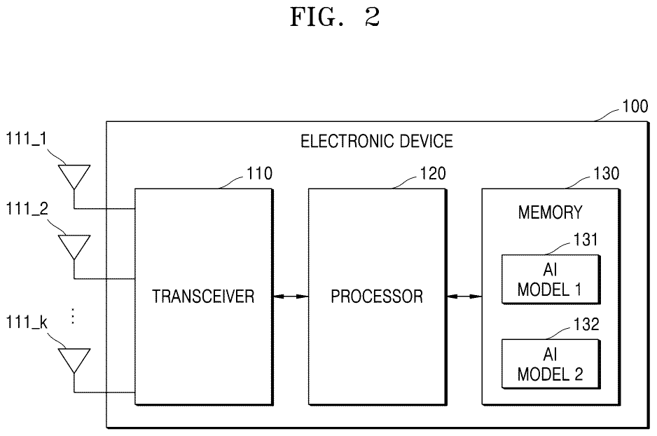

In embodiments, the base stations (that is, 10 and 20) and the user equipment 30 may generate inference results by performing inference operations by using different methods, respectively, based on whether the input data is Out-Of-Distribution (OOD) data. As such, by performing the inference operations by using different methods, respectively, based on whether the input data is OOD data, the performance of the base stations (that is, 10 and 20) and the user equipment 30 may improve. A more specific method of generating an inference result by performing an inference operation by using a different method based on whether the input data is OOD data is described below with reference to FIG. 2.

FIG. 2 is a block diagram illustrating an electronic device according to embodiments.

Referring to FIG. 2, an electronic device 100 according to embodiments may include a transceiver 110, a plurality of antennas 111_1 to 111_k, a processor 120, and/or a memory 130.

The electronic device 100 according to embodiments may correspond to one of the user equipment 30 and/or the base stations (that is, 10 and/or 20), which are included in the wireless communication system 1 of FIG. 1. However, the inventive concepts are not limited thereto, and the electronic device 100 according to embodiments may be a device capable of performing an inference operation by using an AI model, based on input data.

The transceiver 110 may receive, through the plurality of antennas 111_1 to 111_k, a radio signal transmitted by a base station. The transceiver 110 may generate an intermediate-frequency signal or a baseband signal by down-converting the received radio signal. The transceiver 110 may perform a pre-processing (or processing) operation on the radio signal and may transmit the converted radio signal as input data to the processor 120.

Although FIG. 2 illustrates an example in which the radio signal received via the transceiver 110 is used as the input data, the inventive concepts are not limited thereto. In another example, data received from another device external to the electronic device 100 in a wired or wireless manner may be used as the input data. In another example, data generated within the electronic device 100 may be used as the input data.

The processor 120 may control all operations of the electronic device 100. The processor 120 may be a processor having a structure suitable to perform all operations of the electronic device 100. In embodiments, to generate an inference result by performing an inference operation by using an AI model, the processor 120 may include an AI accelerator and/or a Neural Processing Unit (NPU).

The memory 130 may store data that is used by the processor 120. For example, the memory 130 may include volatile memory, such as Static Random Access Memory (SRAM), Dynamic Random Access Memory (DRAM), or the like. However, the inventive concepts are not limited thereto, and the memory 130 may include any type of memory capable of being accessed by the processor 120, for example, nonvolatile memory, such as flash memory, Phase-change Random Access Memory (PRAM), Magnetic Random Access Memory (MRAM), Ferroelectric Random Access Memory (FeRAM), or the like.

In embodiments, the memory 130 may store a first AI model 131 and a second AI model 132. For example, each of the first AI model 131 and the second AI model 132 may include one of models, such as a Convolution Neural Network (CNN), a Recurrent Neural Network (RNN), a transformer, and the like.

The first AI model 131 may be a model trained to determine whether the input data (when referenced in the context of AI model training, the input data may also be referred to herein as training input data) is OOD data. The OOD data may refer to data that is not included in a distribution of specific data. In embodiments, the OOD data may refer to data which is not included in a distribution of training data (e.g., training input data) that is data used for training the second AI model 132 described below. In addition, In-Distribution (ID) data may refer to data that is included in the distribution of specific data. In embodiments, the ID data may refer to data which is included in the distribution of training data that is data used for training the second AI model 132 described below.

The first AI model 131 may be trained to determine whether the input data (e.g., the training input data) is OOD data by using various methods, such as a method of using the distance (for example, the Mahalanobis distance or the like) between the training data distribution and the input data, a method of using a reconstruction error generated when an input is reconstructed via an auto-encoder, and the like.

The second AI model 132 may be a model trained to perform a first inference operation based on the input data. The first inference operation may be an operation of inferring a value, a state or the like, which is unknown, based on specified data such as the input data. In embodiments, the first inference operation may be an operation of deriving a first inference result based on the input data. For example, the first inference operation may be an operation of determining a beam that is to be used for transmitting a radio signal in a beam tracking operation, and the first inference result may be an index of the beam that is to be used for transmitting the radio signal.

The second AI model 132 may be trained to perform the first inference operation by using training data. That is, the second AI model 132 may be a model trained to perform the first inference operation by using the training data that is ID data, and the first AI model 131 may be a model trained to determine whether the input data is OOD data by using a distribution of data used for training the second AI model 132.

In embodiments, the processor 120 may operate by using the first AI model 131 and the second AI model 132, which are stored in the memory 130. The processor 120 may determine whether the input data is OOD data by using the first AI model 131. According to embodiments, in the context of using the trained AI models by the processor 120, the input data may be referred to as first input data (or second input data). The first input data (or second input data) may be of the same type of data as (or a similar type of data to) the training input data. The processor 120 may generate the first inference result by performing the first inference operation by using one of the second AI model 132 and/or a legacy algorithm, based on whether the input data is OOD data. The processor 120 may perform a control operation based on the first inference result.

In embodiments, when it is determined that the input data is not OOD data, the processor 120 may generate the first inference result by performing the first inference operation by using the second AI model 132. That is, when the input data is data that is included in the distribution of training data, the processor 120 may use the second AI model 132.

In embodiments, when it is determined that the input data is OOD data, the processor 120 may generate the first inference result by performing the first inference operation by using the legacy algorithm. The legacy algorithm may be a method of performing the first inference result based on an algorithm such as a preset (or alternatively, given) mathematical expression without using an AI model. That is, when the input data is data that is not included in the distribution of training data, the processor 120 may use the legacy algorithm without using the second AI model 132. Although not shown in FIG. 2, the legacy algorithm may be stored in the memory 130.

In embodiments, the processor 120 may generate the first inference result by performing the first inference operation by using one of the second AI model 132 and/or a result of performing a previous first inference operation, based on whether the input data is OOD data. The processor 120 may perform a control operation based on the first inference result.

In embodiments, when it is determined that the input data is OOD data, the processor 120 may generate the first inference result by performing the first inference operation by using the result of performing the previous first inference operation. The result of performing the previous first inference operation may be a first inference result which the processor 120 has generated by performing the first inference operation by using the second AI model 132 when it has been determined that the input data is not OOD data. That is, when the input data is data that is not included in the distribution of training data, the processor 120 may generate the result of performing the previous first inference operation, intactly (e.g., without modification) as the first inference result without using the second AI model 132. Although not shown in FIG. 2, the result of performing the previous first inference operation may be stored in a buffer inside the processor 120 or in the memory 130.

In embodiments, although not shown in FIG. 2, the memory 130 may further store a third AI model.

The third AI model may be a model trained to perform a second inference operation based on the input data. The second inference operation may be an operation of inferring a value, a state or the like, which is unknown, based on specified data such as the input data, but may be different from the first inference operation. In embodiments, the second inference operation may be an operation of deriving a second inference result based on the input data.

The third AI model may be trained to perform the second inference operation by using training data. That is, the third AI model may be a model trained to perform the second inference operation by using the training data that is ID data, and the first AI model 131 may be trained to determine whether the input data is OOD data by using a distribution of data used for training the third AI model.

The processor 120 may generate the second inference result by performing the second inference operation by using one of the third AI model and/or the legacy algorithm, based on whether the input data is OOD data. The processor 120 may perform a control operation based on the second inference result.

In embodiments, when it is determined that the input data is not OOD data, the processor 120 may generate the second inference result by performing the second inference operation by using the third AI model. That is, when the input data is data that is included in the distribution of training data, the processor 120 may use the third AI model.

In embodiments, when it is determined that the input data is OOD data, the processor 120 may generate the second inference result by performing the second inference operation by using the legacy algorithm. In embodiments, when it is determined that the input data is OOD data, the processor 120 may generate the second inference result by performing the second inference operation by using a result of performing a previous second inference operation.

In embodiments, when it is determined that the input data is not OOD data, the processor 120 may determine whether the input data is In-Distribution Obvious (IDO) data by using the first AI model 131. The IDO data may refer to data for which an inference result based on input data is obvious, among data that is included in a distribution of specific data. That is, when the input data is IDO data, the first inference result may be derived even without performing the first inference operation by using the second AI model 132.

Therefore, in the case where it is determined that the input data is not OOD data, when it is determined that the input data is not IDO data, the processor 120 may generate the first inference result by performing the first inference operation by using the second AI model 132. On the other hand, in the case where it is determined that the input data is not OOD data, when it is determined that the input data is IDO data, the processor 120 may generate a preset (or alternatively, given) inference result as the first inference result.

The processor 120 may perform a control operation based on the first inference result. More specifically, the processor 120 may perform the control operation based on the first inference result generated by using one of the second AI model 132, the legacy algorithm, and/or the result of performing the previous first inference operation, according to the type of the input data. For example, the processor 120 may perform a control operation for transmitting a radio signal via the transceiver 110 based on an index of a beam that is to be used for the transmission of the radio signal, the index being selected as the first inference result. According to embodiments, the processor 120 and/or the transceiver 110 generate complex symbols by encoding and modulating a transmission bit string, may up-convert the baseband signal into a radio frequency (RF) band signal and transmit the RF band signal (e.g., a time-varying voltage signal in the RF band) through one or more among the plurality of antennas 111_1 to 111_k. For example, the transceiver 110 may include a transmission filter, a reception filter, an amplifier, a mixer, an oscillator, a digital to analog converter (DAC), an analog to digital converter (ADC), etc. According to embodiments, the processor 120 and/or the transceiver 110 may perform beamforming including applying a beamforming weight to the RF band signal to be transmitted based on the selected beam index in order to provide directionality to the transmitted RF band signal.

The processor 120 may determine whether there is a need to update (or whether to update) the second AI model 132, based on a result of determining the input data to be OOD data. When the input data determined to be OOD data is continuously received, this may mean that the distribution of input data has changed to be different from the distribution of training data due to a change in an external environment. According to embodiments, in the context of continuously recited input data determined to be OOD data, the input data may be referred to herein as second input data (or third input data). The second input data (or third input data) may be the same type of data as (or a similar type of data to) the first input data (or the second input data), and/or may include the first input data (or second input data).

In embodiments, when a proportion of determining the input data to be OOD data (e.g., a proportion of such determinations made) during a preset (or alternatively, given) time window (may also be referred to herein as a set, fixed and/or stored time window) is a reference proportion or more, the processor 120 may determine that there is a need to update (or may determine to update) the second AI model 132. For example, in the case where the preset (or alternatively, given) time window is a total of 10 s and the reference proportion is 50 %, when the proportion of determining the input data to be OOD data for 10 s is 50 % or more, the processor 120 may determine that there is a need to update (or may determine to update) the second AI model 132.

In embodiments, when it is determined consecutively a reference number of times or more that the input data is OOD data, the processor 120 may determine that there is a need to update (or may determine to update) the second AI model 132. For example, in the case where the reference number of times is 5 times, when it is determined consecutively 5 times that the input data is OOD data, the processor 120 may determine that there is a need to update (or may determine to update) the second AI model 132.

When it is determined that there is a need to update (or when it is determined to update) the second AI model 132, the processor 120 may update the second AI model 132.

In embodiments, when it is determined that there is a need to update (or when it is determined to update) the second AI model 132, the processor 120 may replace the second AI model 132 by an AI model trained based on training data having a distribution similar to the distribution of input data determined to be OOD data, thereby updating the second AI model 132. That is, the second AI model 132 may be replaced by an AI model capable of performing the first inference operation that is most suitable for current input data, among already trained AI models.

In embodiments, when it is determined that there is a need to update (e.g., when it is determined to update) the second AI model 132, the processor 120 may train the second AI model 132 by using the input data determined to be OOD data (e.g., a portion of the second input data determined to be OOD data), thereby updating the second AI model 132. That is, the processor 120 may perform fine tuning on the second AI model 132 by using the input data determined to be OOD data, thereby updating the second AI model 132.

The electronic device 100 according to embodiments, which is described above, may generate an inference result by using the second AI model, the legacy algorithm, and/or the previous inference result, based on whether the input data is OOD data. In this way, by reducing an error in an inference operation in an environment in which the input data rapidly changes, the stability of the electronic device 100 may improve. In addition, unnecessary calculations, adjustments, and the like, occurring due to a rapid change in the input data may be reduced, thereby improving resource efficiency. Furthermore, when the electronic device 100 is used in the wireless communication system 1 shown in FIG. 1, stable communication network performance may be secured by quickly sensing and dealing with abnormal input data.

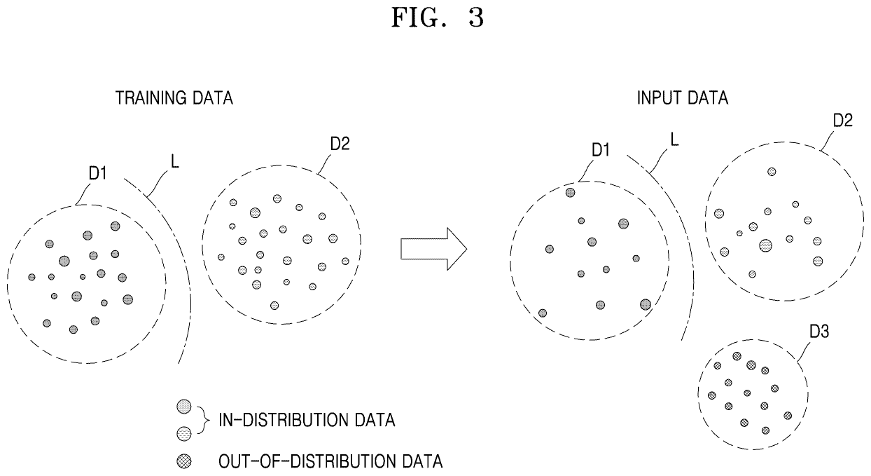

FIG. 3 is a diagram illustrating OOD data and a relationship between training data and input data.

Referring to FIG. 3, it may be seen that training data is shown on the left side. The t raining data may be classified to fall within one of a first distribution D1 or a second distribution D2 according to a boundary line L represented by a dash-dotted line. Here, the training data may be preset (or alternatively, given) data. Thus, the training data may be necessarily included (or otherwise, may be included) in one of the first distribution D1 and/or the second distribution D2, and all the training data may be ID data.

On the right side, it may be seen that input data is classified into one of the first distribution D1, the second distribution D2, and/or a third distribution D3, based on the training data. The input data may be classified to fall within one of the first distribution D1 or the second distribution D2 according to the boundary line L represented by a dash-dotted line. Among pieces of input data, a piece of data, which is not clearly classified to fall within one of the first distribution D1 or the second distribution D2 based on the boundary line L, may be classified into the third distribution D3. Here, the data classified into the third distribution D3 may be OOD data. Although FIG. 3 illustrates that all pieces of OOD data are included in the third distribution D3 for convenience of illustration, all pieces of data, which are not classified into one of the first distribution D1 or the second distribution D2 even though not included in the third distribution D3, may be classified as OOD data.

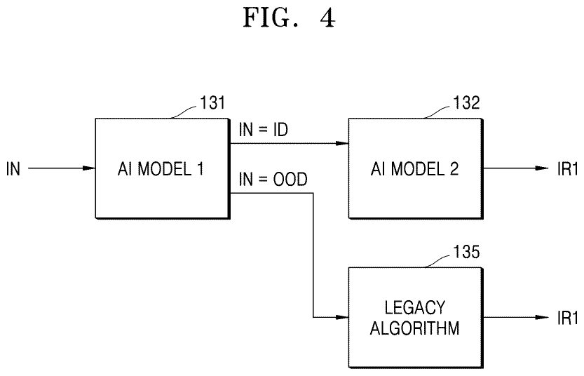

FIG. 4 is a first example of a method, performed by an electronic device, of generating an inference result based on input data, according to embodiments.

Referring to FIG. 4, an example of a method of generating a first inference result IR1 by processing input data IN in the electronic device 100 is illustrated. The example of FIG. 4 may be an example of generating the first inference result IR1 by using the first AI model 131, the second AI model 132, and a legacy algorithm block 135.

First, the input data IN may be input to the first AI model 131. The first AI model 131 may determine whether the input data IN is OOD data OOD. That is, the first AI model 131 may determine the input data IN to be one of ID data ID or the OOD data OOD.

When the input data IN is determined to be the ID data ID (that is, in response to determining IN=ID), the first AI model 131 may output the input data IN to the second AI model 132. The second AI model 132 may generate a first inference result IR1 by performing a first inference operation based on the input data IN.

When the input data IN is determined to be the OOD data OOD (that is, IN=OOD), the first AI model 131 may output the input data IN to the legacy algorithm block 135. The legacy algorithm block 135 may generate the first inference result IR1 by performing a first inference operation based on the input data IN by using a legacy algorithm. According to embodiments, the electronic device 100 may determine which (e.g., select) among the second AI model 132 and the legacy algorithm block 135 to use in performing the first inference operation.

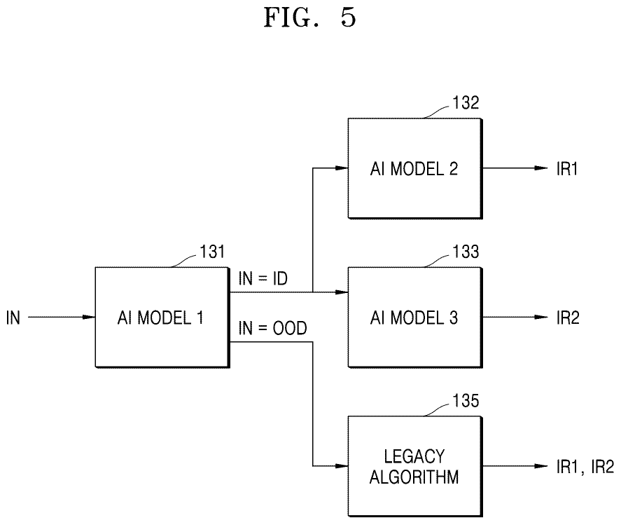

FIG. 5 is a second example of a method, performed by an electronic device, of generating an inference result based on input data, according to embodiments.

Referring to FIG. 5, an example of a method of generating the first inference result IR1 and/or a second inference result IR2 by processing the input data IN in the electronic device 100 is illustrated. The example of FIG. 5 may be an example of generating the first inference result IR1 and/or the second inference result IR2 by using the first AI model 131, the second AI model 132, a third AI model 133, and/or the legacy algorithm block 135.

First, the input data IN may be input to the first AI model 131. The first AI model 131 may determine the input data IN to be one of the ID data ID or the OOD data OOD.

When the input data IN is determined to be the ID data ID (that is, in response to determining IN=ID), the first AI model 131 may output the input data IN to the second AI model 132 and the third AI model 133. The second AI model 132 may generate the first inference result IR1 by performing a first inference operation based on the input data IN. The third AI model 133 may generate the second inference result IR2 by performing a second inference operation based on the input data IN.

When the input data IN is determined to be the OOD data OOD (that is, in response to determining IN=OOD), the first AI model 131 may output the input data IN to the legacy algorithm block 135. The legacy algorithm block 135 may generate the first inference result IR1 and the second inference result IR2 by performing the first inference operation and the second inference operation based on the input data IN by using a legacy algorithm. According to embodiments, the electronic device 100 may determine which (e.g., select) among the second AI model 132, the third AI model 133 and the legacy algorithm block 135 to use in performing the first and second inference operations.

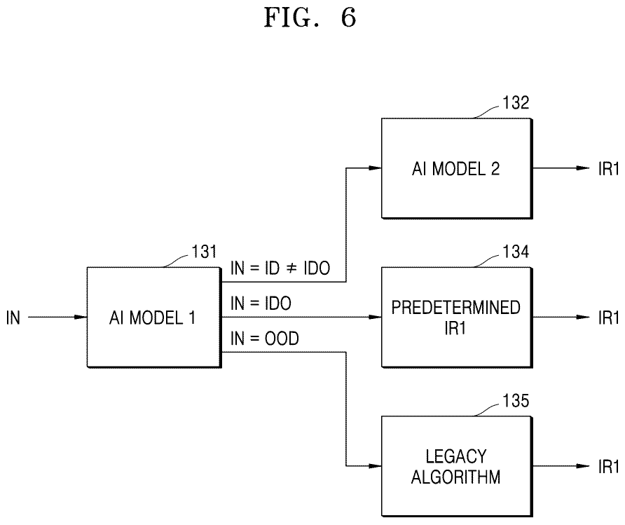

FIG. 6 is a third example of a method, performed by an electronic device, of generating an inference result based on input data, according to embodiments.

Referring to FIG. 6, an example of a method of generating the first inference result IR1 by processing the input data IN in the electronic device 100 is illustrated. The example of FIG. 6 may be an example of generating the first inference result IR1 by using the first AI model 131, the second AI model 132, a preset (or alternatively, given) first inference result block 134, and/or the legacy algorithm block 135.

First, the input data IN may be input to the first AI model 131. The first AI model 131 may determine the input data IN to be one of the ID data ID, IDO data IDO, or the OOD data OOD.

When the input data IN is determined to be the ID data ID (that is, in response to determining IN=ID≠IDO), the first AI model 131 may output the input data IN to the second AI model 132. The second AI model 132 may generate the first inference result IR1 by performing a first inference operation based on the input data IN.

When the input data IN is determined to be the IDO data IDO (that is, in response to determining IN=IDO), the first AI model 131 may output the input data IN to the preset (or alternatively, given) first inference result block 134. The preset (or alternatively, given) first inference result block 134 may generate a preset (or alternatively, given) first inference result as the first inference result IR1. According to embodiments, the preset (or alternatively, given) first inference result may also be referred to herein as a set, fixed and/or stored first interference result.

When the input data IN is determined to be the OOD data OOD (that is, in response to determining IN=OOD), the first AI model 131 may output the input data IN to the legacy algorithm block 135. The legacy algorithm block 135 may generate the first inference result IR1 by performing the first inference operation based on the input data IN by using a legacy algorithm. According to embodiments, the electronic device 100 may determine which (e.g., select) among the second AI model 132, the preset (or alternatively, given) first inference result block 134 and the legacy algorithm block 135 to use in performing the first inference operation.

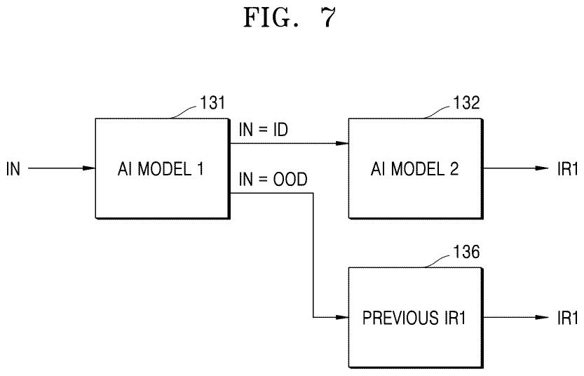

FIG. 7 is a fourth example of a method, performed by an electronic device, of generating an inference result based on input data, according to embodiments.

Referring to FIG. 7, an example of a method of generating the first inference result IR1 by processing the input data IN in the electronic device 100 is illustrated. The example of FIG. 7 may be an example of generating the first inference result IR1 by using the first AI model 131, the second AI model 132, and/or a previous first inference result block 136.

First, the input data IN may be input to the first AI model 131. The first AI model 131 may determine the input data IN to be one of the ID data ID or the OOD data OOD.

When the input data IN is determined to be the ID data ID (that is, in response to determining IN=ID), the first AI model 131 may output the input data IN to the second AI model 132. The second AI model 132 may generate the first inference result IR1 by performing a first inference operation based on the input data IN.

When the input data IN is determined to be the OOD data OOD (that is, in response to determining IN=OOD), the first AI model 131 may output the input data IN to the previous first inference result block 136. The previous first inference result block 136 may generate a previous first inference result as the first inference result IR1. According to embodiments, the electronic device 100 may determine which (e.g., select) among the second AI model 132 and previous first inference result block 136 to use in performing the first inference operation.

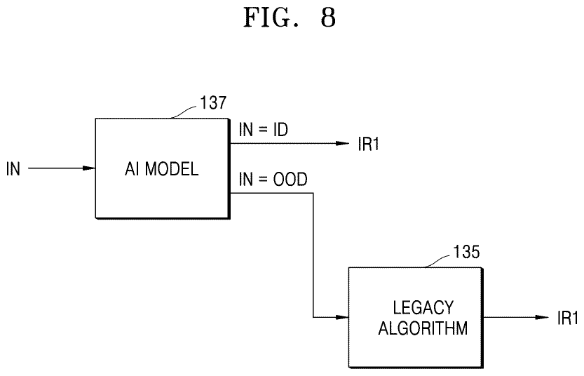

FIG. 8 is a fifth example of a method, performed by an electronic device, of generating an inference result based on input data, according to embodiments.

Referring to FIG. 8, an example of a method of generating the first inference result IR1 by processing the input data IN in the electronic device 100 is illustrated. The example of FIG. 8 may be an example of generating the first inference result IR1 by using an AI model 137 and/or the legacy algorithm block 135.

First, the input data IN may be input to the AI model 137. In the example of FIG. 8, the AI model 137 may be a model into which the first AI model 131 and the second AI model are integrated.

The AI model 137 may determine the input data IN to be one of the ID data ID or the OOD data OOD.

When the input data IN is determined to be the ID data ID (that is, in response to determining IN=ID), the AI model 137 may generate the first inference result IR1 by performing a first inference operation based on the input data IN.

When the input data IN is determined to be the OOD data OOD (that is, in response to determining IN=OOD), the AI model 137 may output the input data IN to the legacy algorithm block 135. The legacy algorithm block 135 may generate the first inference result IR1 by performing the first inference operation based on the input data IN by using a legacy algorithm.

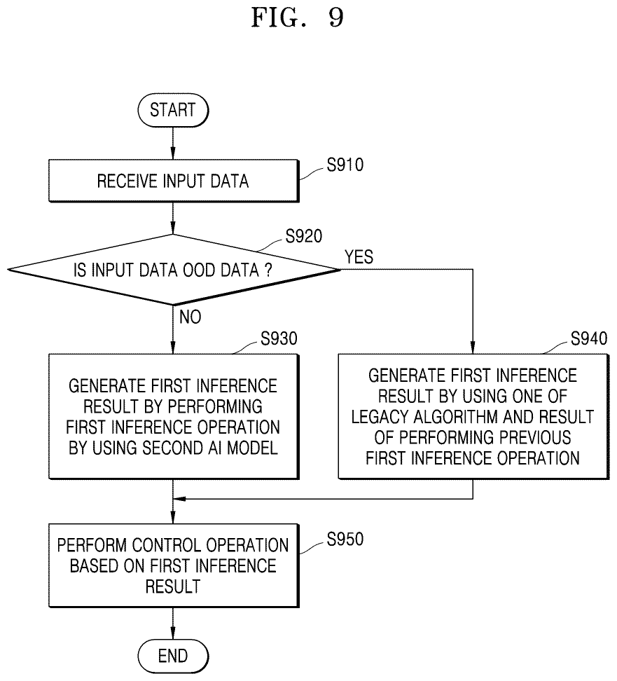

FIG. 9 is a flowchart illustrating an operation method of an electronic device, according to embodiments.

Referring to FIG. 9, in operation S910, the electronic device 100 may receive input data. When the electronic device 100 is included in the wireless communication system 1, the electronic device 100 may receive a radio signal as the input data via the transceiver 110.

In operation S920, the electronic device 100 may determine whether the input data is OOD data. The electronic device 100 may determine the input data to be one of OOD data and ID data by using the first AI model 131.

When it is determined that the input data is not OOD data, the operation method may proceed to operation S930, and thus, the electronic device 100 may generate a first inference result by performing a first inference operation by using the second AI model 132.

That is, when the input data is ID data, because an appropriate first inference result may be obtained by using the second AI model 132, the electronic device 100 may generate the first inference result by performing the first inference operation by using the second AI model 132.

On the other hand, when it is determined that the input data is OOD data, the operation method may proceed to operation S940, and thus, the electronic device 100 may generate the first inference result by using one of a legacy algorithm and/or a result of performing a previous first inference operation.

That is, when the input data is OOD data, because an appropriate first inference result is not able to be obtained by using the second AI model 132, the electronic device 100 may generate the first inference result by using, as an alternative method, one of the legacy algorithm and/or the result of performing the previous first inference operation, instead of using the second AI model 132.

In operation S950, the electronic device 100 may perform a control operation based on the first inference result generated through operation S930 or S940. As such, the electronic device 100 may perform the control operation by using the first inference result generated by a different method according to whether the input data is OOD data, thereby improving the performance of the electronic device 100.

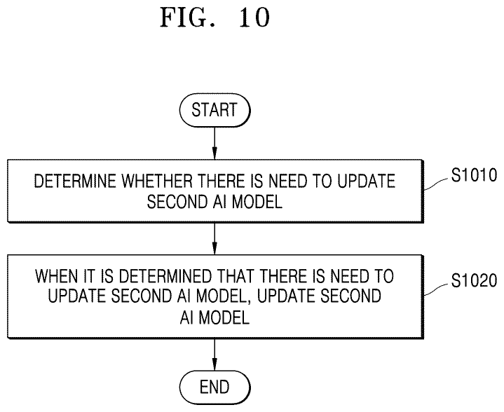

FIG. 10 is a flowchart illustrating an additional operation method of an electronic device, according to embodiments.

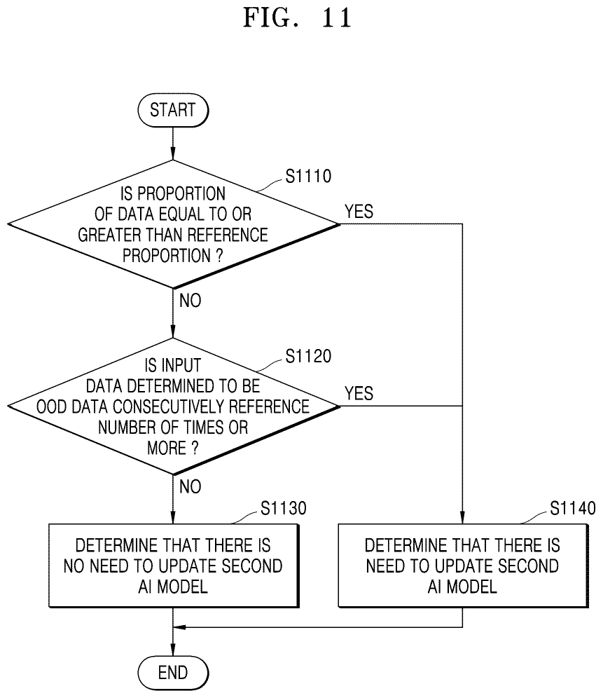

Referring to FIG. 10, in operation S1010, the electronic device 100 may determine whether there is a need to update (or whether to update) the second AI model 132. The electronic device 100 may determine whether there is a need to update (or whether to update) the second AI model 132, based on a result of determining input data to be OOD data. An example of a more specific method of determining whether there is a need to update (or whether to update) the second AI model 132 may be described with reference to FIG. 11.

FIG. 11 is a flowchart illustrating a method, performed by an electronic device, of determining whether there is a need to update (or whether to update) a second AI model, according to embodiments.

Referring to FIG. 11, in operation S1110, the electronic device 100 may determine whether the proportion of OOD data is a reference proportion or more. Here, the electronic device 100 may determine whether the proportion of determining input data to be OOD data during a preset (or alternatively, given) time window is the reference proportion or more.

When it is determined that the proportion of OOD data is the reference proportion or more, the operation method may proceed to operation S1140, and thus, the electronic device 100 may determine that there is a need to update (or determine to update) the second AI model 132.

When it is determined that the proportion of OOD data is less than the reference proportion, the operation method may proceed to operation S1120, and thus, the electronic device 100 may determine whether the input data has been determined to be OOD data consecutively a reference number of times or more.

When it is determined that the input data has been determined to be OOD data consecutively the reference number of times or more, the operation method may proceed to operation S1140, and thus, the electronic device 100 may determine that there is a need to update (or determine to update) the second AI model 132.

When it is determined that the input data has not been determined to be OOD data consecutively the reference number of times or more, the operation method may proceed to operation S1130, and thus, the electronic device 100 may determine that there is no need to update (or determine not to update) the second AI model 132.

Although FIG. 11 illustrates an example in which whether there is a need to update (or whether to update) the second AI model 132 is determined based on the proportion of OOD data and on whether the input data has been determined to be OOD data consecutively the reference number of times or more, the inventive concepts are not limited thereto. Unlike the example of FIG. 11, whether there is a need to update (or whether to update) the second AI model 132 may be determined based on only one of the criterion of the proportion of OOD data or the criterion of whether the input data has been determined to be OOD data consecutively the reference number of times or more, or whether there is a need to update (or whether to update) the second AI model 132 may be determined by additionally using another criterion.

Referring again to FIG. 10, in operation S1020, when it is determined that there is a need to update (or when it is determined to update) the second AI model 132, the electronic device 100 may update the second AI model 132.

In embodiments, the electronic device 100 may replace the second AI model 132 by an AI model trained based on training data having a similar distribution to that of the input data determined to be OOD data, thereby updating the second AI model 132. In embodiments, the electronic device 100 may train the second AI model 132 based on the input data determined to be OOD data, thereby updating the second AI model 132.

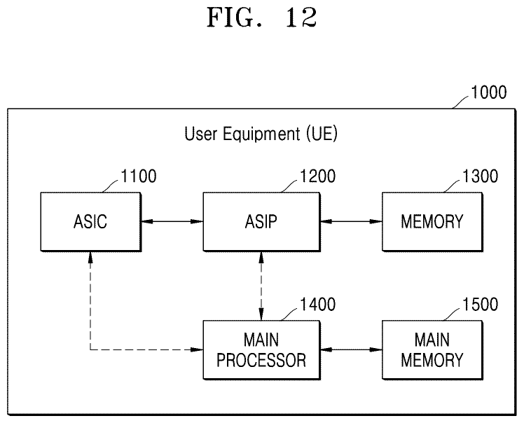

FIG. 12 is a block diagram illustrating a user equipment according to embodiments.

Referring to FIG. 12, a user equipment 1000 may include an Application-Specific Integrated Circuit (ASIC) 1100, an Application-Specific Instruction set Processor (ASIP) 1200, a memory 1300, a main processor 1400, and/or a main memory 1500. Two or more of the ASIC 1100, the ASIP 1200, and/or the main processor 1400 may communicate with each other. In addition, at least two of the ASIC 1100, the ASIP 1200, the memory 1300, the main processor 1400, and/or the main memory 1500 may be embedded in a single chip.

The ASIC 1100 is an integrated circuit customized for a particular use and may include, for example, radio-frequency integrated circuit (RFIC), a modulator, demodulator, or the like. The ASIP 1200 may support a dedicated instruction set for a particular application and may execute instructions that are included in the instruction set. The memory 1300 may communicate with the ASIP 1200 and, as a non-transitory storage device, may store a plurality of instructions executed by the ASIP 1200. For example, the memory 1300 may include any type of memory capable of being accessed by the ASIP 1200, such as Random-Access Memory (RAM), Read-Only Memory (ROM), tape, a magnetic disk, an optical disk, volatile memory, nonvolatile memory, and a combination thereof.

The main processor 1400 may control the user equipment 1000 by executing a plurality of instructions. For example, the main processor 1400 may control the ASIC 1100 and the ASIP 1200, and may process data received via a wireless communication network or may process a user input to the user equipment 1000. The main memory 1500 may communicate with the main processor 1400 and, as a non-transitory storage device, may store a plurality of instructions executed by the main processor 1400. For example, the main memory 1500 may include any type of memory capable of being accessed by the main processor 1400, such as RAM, ROM, tape, a magnetic disk, an optical disk, volatile memory, nonvolatile memory, and a combination thereof.

A component of the electronic device 100 according to embodiments, which is described with reference to FIGS. 2 to 11, may correspond to or be included in at least one of the components of the user equipment 1000 of FIG. 12. For example, the memory 130 of the electronic device 100 of FIG. 2 may be implemented in the memory 1300 of the user equipment 1000 of FIG. 12, and the processor 120 of the electronic device 100 of FIG. 2 may correspond to the ASIP 1200 of the user equipment 1000 of FIG. 12.

According to an aspect of the inventive concepts, there is provided a non-transitory computer-readable medium storing instructions that, when executed by processing circuitry of an electronic device, cause the electronic device to perform an operation method, the operation method including receiving first input data, determining whether the first input data is Out-Of-Distribution (OOD) data using a first Artificial Intelligence (AI) model, generating a first inference result by performing a first inference operation using a second AI model in response to determining the first input data is the OOD data, performing a first control operation based on the first inference result, receiving second input data, determining whether the second input data is the OOD data using the first AI model, generating a second inference result by using one of a legacy algorithm or a result of performing a previous first inference operation, and performing a second control operation based on the second inference result.

Conventional devices and methods for performing beam tracking may determine a beam using an AI model. However, in scenarios in which data input to the AI model for use in determining the beam differs from training data used to obtain the AI model, the conventional devices and methods are unable to infer the correct beam with sufficient accuracy. Accordingly, the conventional devices and methods suffer from insufficient communication performance.

However, according to embodiments, improved devices and methods are provided for performing beam tracking. For example, the improved devices and methods use a first AI model trained to determine whether input data is within a distribution of data used to train a second AI model, and use the second AI model to infer the correct beam based on a determination by the first AI model that the input data is within the distribution. Accordingly, the improved devices and methods use the second AI model to infer the correct beam in scenarios in which the second AI model is trained to do so accurately. The improved devices and methods determine the correct beam using alternative approaches (e.g., a legacy algorithm, etc.) in scenarios in which the second AI model may be unable to infer the correct beam accurately. Therefore, the improved devices and methods overcome the deficiencies of the conventional devices and methods to more accurately infer the correct beam for beam tracking, and thus, improve communication performance.

According to embodiments, operations described herein as being performed by the wireless communication system 1, each of the base stations 10 and 20, the user equipment 30, the electronic device 100, the transceiver 110, the processor 120, the legacy algorithm block 135, the preset (or alternatively, given) first inference result block 134, the previous first inference result block 136, the user equipment 1000, the ASIC 1100, the ASIP 1200, and/or the main processor 1400 may be performed by processing circuitry. The term ‘processing circuitry,’ as used in the present disclosure, may refer to, for example, hardware including logic circuits; a hardware/software combination such as a processor executing software; or a combination thereof. For example, the processing circuitry more specifically may include, but is not limited to, a central processing unit (CPU), an arithmetic logic unit (ALU), a graphics processing unit (GPU), a digital signal processor, a microcomputer, a field programmable gate array (FPGA), a System-on-Chip (SoC), a programmable logic unit, a microprocessor, application-specific integrated circuit (ASIC), etc.

In embodiments, the processing circuitry may perform some operations (e.g., the operations described herein as being performed by the first AI model 131, the second AI model 132, the third AI model 133 and/or the AI model 137) by artificial intelligence and/or machine learning. As an example, the processing circuitry may implement an artificial neural network (e.g., the first AI model 131, the second AI model 132, the third AI model 133 and/or the AI model 137) that is trained on a set of training data by, for example, a supervised, unsupervised, and/or reinforcement learning model, and wherein the processing circuitry may process a feature vector to provide output based upon the training. Such artificial neural networks may utilize a variety of artificial neural network organizational and processing models, such as convolutional neural networks (CNN), recurrent neural networks (RNN) optionally including long short-term memory (LSTM) units and/or gated recurrent units (GRU), stacking-based deep neural networks (S-DNN), state-space dynamic neural networks (S-SDNN), deconvolution networks, deep belief networks (DBN), and/or restricted Boltzmann machines (RBM). Alternatively or additionally, the processing circuitry may include other forms of artificial intelligence and/or machine learning, such as, for example, linear and/or logistic regression, statistical clustering, Bayesian classification, decision trees, dimensionality reduction such as principal component analysis, and expert systems; and/or combinations thereof, including ensembles such as random forests.

Herein, the machine learning model (e.g., the first AI model 131, the second AI model 132, the third AI model 133 and/or the AI model 137) may have any structure that is trainable, e.g., with training data. For example, the machine learning model may include an artificial neural network, a decision tree, a support vector machine, a Bayesian network, a genetic algorithm, and/or the like. The machine learning model may be described herein by mainly referring to an artificial neural network, but embodiments are not limited thereto. Non-limiting examples of the artificial neural network may include a convolution neural network (CNN), a region based convolution neural network (R-CNN), a region proposal network (RPN), a recurrent neural network (RNN), a stacking-based deep neural network (S-DNN), a state-space dynamic neural network (S-SDNN), a deconvolution network, a deep belief network (DBN), a restricted Boltzmann machine (RBM), a fully convolutional network, a long short-term memory (LSTM) network, a classification network, and/or the like.

The various operations of methods described above may be performed by any suitable device capable of performing the operations, such as the processing circuitry discussed above. For example, as discussed above, the operations of methods described above may be performed by various hardware and/or software implemented in some form of hardware (e.g., processor, ASIC, etc.).

The software may comprise an ordered listing of executable instructions for implementing logical functions, and may be embodied in any “processor-readable medium” for use by or in connection with an instruction execution system, apparatus, or device, such as a single or multiple-core processor or processor-containing system.

The blocks or operations of a method or algorithm, and/or functions, described in connection with embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art.

Embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail herein. Although discussed in a particular manner, a function or operation specified in a specific block may be performed differently from the flow specified in a flowchart, flow diagram, etc. For example, functions or operations illustrated as being performed serially in two consecutive blocks may actually be performed concurrently, simultaneously, contemporaneously, or in some cases be performed in reverse order.

Although terms of “first” or “second” may be used to explain various components, the components are not limited to the terms. These terms should be used only to distinguish one component from another component. For example, a “first” component may be referred to as a “second” component, or similarly, and the “second” component may be referred to as the “first” component. Expressions such as “at least one of” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples. As used herein the term “and/or” includes any and all combinations of one or more of the associated listed items.

When one constituent element is described as being “coupled” or “connected” to another constituent element, it should be understood that one constituent element may be coupled or connected directly to another constituent element, and an intervening constituent element may also be present between the constituent elements. When one constituent element is described as being “coupled directly to” or “connected directly to” another constituent element, it should be understood that no intervening constituent element exists between the constituent elements.

Heretofore, the inventive concepts have been particularly shown and described with reference to embodiments thereof and the accompanying drawings. Although embodiments have been described herein by using particular terms, these terms used herein are only for describing the inventive concepts and are not intended to limit the scope of the inventive concepts, which is defined by the appended claims. Therefore, it will be understood by those of ordinary skill in the art that there may be various modifications and equivalent examples made from embodiments of the inventive concepts. Therefore, the scope of the inventive concepts should be defined by the appended claims.

What is claimed is:

1. An electronic device comprising:
a memory storing a first Artificial Intelligence (AI) model and a second AI model, the first AI model being trained to determine whether training input data is Out-Of-Distribution (OOD) data, the second AI model being trained to perform a first inference operation based on the training input data; and
processing circuitry configured to,
determine whether first input data is the OOD data by using the first AI model,
generate a first inference result by performing the first inference operation using one of the second AI model or a legacy algorithm based on whether the first input data is the OOD data, and
perform a control operation based on the first inference result.

2. The electronic device of claim 1, wherein the first AI model is trained to determine whether the training input data is the OOD data based on a distribution of data used for training the second AI model.

3. The electronic device of claim 1, wherein the processing circuitry is configured to generate the first inference result by performing the first inference operation using the second AI model in response to determining the first input data is not the OOD data.

4. The electronic device of claim 1, wherein the processing circuitry is configured to generate the first inference result by performing the first inference operation using the legacy algorithm in response to determining the first input data is the OOD data.

5. The electronic device of claim 1, wherein
the memory stores a third AI model trained to perform a second inference operation based on the training input data; and
the processing circuitry is configured to,
generate a second inference result by performing the second inference operation using the third AI model in response to determining the first input data is not the OOD data;
generate the second inference result by performing the second inference operation using the legacy algorithm in response to determining the first input data is the OOD data; and
perform the control operation based on the second inference result.

6. The electronic device of claim 1, wherein the processing circuitry is configured to:
determine whether the first input data is In-Distribution Obvious (IDO) data using the first AI model in response to determining the first input data is not the OOD data;
generate the first inference result by performing the first inference operation using the second AI model in response to determining the first input data is not the IDO data; and
generate a set inference result as the first inference result in response to determining the first input data is the IDO data.

7. The electronic device of claim 1, wherein
the first inference operation includes determining a beam to be used for transmitting a radio signal in a beam tracking operation;
the first inference result is an index of the beam; and
the control operation includes transmitting the radio signal based on the index of the beam.

8. The electronic device of claim 1, wherein the processing circuitry is configured to:
determine whether to update the second AI model based on a result of determining second input data to be the OOD data; and
update the second AI model in response to determining to update the second AI model.

9. The electronic device of claim 8, wherein the processing circuitry is configured to determine to update the second AI model based on a proportion of determinations that the second input data is the OOD data during a time window is a reference proportion or more.

10. The electronic device of claim 8, wherein the processing circuitry is configured to determine to update the second AI model based on the second input data being determined to be the OOD data consecutively a reference number of times or more.

11. The electronic device of claim 8, wherein the processing circuitry is configured to update the second AI model by replacing the second AI model with an AI model that is trained by using training data having a distribution similar to that of a portion of the second input data determined to be the OOD data.

12. The electronic device of claim 8, wherein the processing circuitry is configured to update the second AI model by training the second AI model using a portion of the second input data determined to be the OOD data.

13. An electronic device comprising:
a memory storing a first Artificial Intelligence (AI) model and a second AI model, the first AI model being trained to determine whether training input data is Out-Of-Distribution (OOD) data, the second AI model being trained to perform a first inference operation based on the training input data; and
processing circuitry configured to,
determine whether first input data is the OOD data using the first AI model,
generate a first inference result
by performing the first inference operation using one of the second AI model, or
as a result of performing a previous first inference operation based on whether the first input data is the OOD data, and
perform a control operation based on the first inference result.

14. The electronic device of claim 13, wherein the first AI model is trained to determine whether the training input data is the OOD data using a distribution of data used for training the second AI model.

15. The electronic device of claim 13, wherein the processing circuitry is configured to generate the first inference result by performing the first inference operation using the second AI model in response to determining the first input data is not the OOD data.

16. The electronic device of claim 13, wherein the processing circuitry is configured to generate the first inference result as the result of performing the previous first inference operation in response to determining the first input data is the OOD data.

17. An operation method of an electronic device, the operation method comprising:
receiving first input data;
determining whether the first input data is Out-Of-Distribution (OOD) data using a first Artificial Intelligence (AI) model;
generating a first inference result by performing a first inference operation using a second AI model in response to determining the first input data is the OOD data;
performing a first control operation based on the first inference result;
receiving second input data;
determining whether the second input data is the OOD data using the first AI model;
generating a second inference result by using one of a legacy algorithm or a result of performing a previous first inference operation; and
performing a second control operation based on the second inference result.

18. The operation method of claim 17, further comprising:
determining whether to update the second AI model based on a result of determining third input data to be the OOD data; and
updating the second AI model in response to determining to update the second AI model.

19. The operation method of claim 18, wherein the determining of whether to update the second AI model comprises determining to update the second AI model based on,
a proportion of determinations that the third input data is the OOD data during a set time window being a reference proportion or more, or
the third input data being determined to be the OOD data consecutively a reference number of times or more.

20. The operation method of claim 18, wherein the updating of the second AI model includes updating the second AI model by training the second AI model using a portion of the third input data determined to be the OOD data.
